(19) United States
(12) Patent Application Publication
(10) Pub. No.: US 2007/0164847 A1
(43) Pub. Date: Jul. 19, 2007

(54) SYSTEM AND METHOD FOR LOCKING ELECTRONIC DEVICES

(76) Inventors: Michael Crawford, Newry (IE); Fintan Fairmichael, Belfast (IE); Kevin Tadgh O'Riordan, Tivoli Cork (IE); Stephen Tapley, Lucan County (IE)

Correspondence Address: LOTUS AND RATIONAL SOFTWARE;McGuinness & Manaras LLP, 125 NAGOG PARK, ACTON, MA, 01720, US

(21) Appl. No.: 11/424,609

(22) Filed: Jun. 16, 2006

(30) Foreign Application Priority Data
Jan. 11, 2006 (GB) GB0600465.9

(51) Int. Cl. G05B 19/00

(52) U.S. Cl. 340/5.61; 340/572.1; 340/5.74; 455/411; 340/825.49; 726/3

(57) ABSTRACT

A system and method are provided for locking electronic devices when the devices are not in the same location as a user associated with the device. The system includes a plurality of users each having an identification tag and a plurality of electronic devices each having an identification tag. Location sensors are provided in a room and at entry and exit points for detecting the location of the tags. A database stores the location information of tags and associations of a user with one or more devices. A remote locking means invokes a lock command or an unlock command on an electronic device depending on whether or not the electronic device is in the same location as a user associated with the device. In one embodiment, the identification tags are radio frequency identification transponders and the location sensors are radio frequency identification readers.

### CROSS REFERENCE TO RELATED APPLICATIONS

The present application claims priority under 35 USC 119 to United Kingdom Application Number GB0600465.9, filed Jan. 11, 2006.

### FIELD OF THE INVENTION

This invention relates to the field of security of electronic devices and, in particular, to locking devices to prevent use by unauthorized persons.

### BACKGROUND OF THE INVENTION

The security of information is of crucial importance within the Information Technology (IT) industry. It is as important to protect information within the constraints of an office as it is from external attacks. Taking this into account, many organizations enforce a policy where employees must lock their workstation whenever they are not at their desk. Similarly, other electronic devices that could pose a security risk if left unattended, must also be secured. Examples of these devices include telephones, laptops, and personal digital assistants (PDAs).

In most modern operating systems, a user can set a computer to lock automatically after a specified period of inactivity. However, this solution is not ideal. If an employee leaves his desk without locking his computer, someone else can begin to use the computer straight away keeping it active and preventing the computer from locking.

Known security solutions include apparatus in which a sensor is coupled to a computer and reads a badge of a user. If the badge of an authorized user is not detected by the sensor, the computer locks.

One example of such an apparatus is the pcProx Sonar (trade mark of RFIDeas Inc. see http://www.rfideasstore.com/rfideas/pcproxsonarsdk.html) which is a device that attaches to a personal computer via the USB port and is configured by the system as a keyboard. A user wears a passive RFID (radio frequency identification) badge. If the badge is taken away from the computer, a detector in the device determines this and locks the computer. The device sends commands by keystrokes to lock the computer.

A disadvantage of this apparatus is that the device is attached to the computer and therefore, each computer must have its own device. Another disadvantage is that as the device replicates keystrokes with a time lapse, they are subject to interruption by someone using the keyboard itself. Finally, if the device is removed from the computer, the system will cease to function.

### SUMMARY OF THE INVENTION

According to a first aspect of the present invention there is provided a system for locking electronic devices, comprising: a plurality of identification tags each identifying a user; a plurality of electronic devices each having an identification tag; location sensors for detecting the location of a tag; a database storing location information of tags and associations of a user with a plurality of devices; and a remote locking means to invoke a lock command or an unlock command on an electronic device.

The remote locking means may invoke a lock command or an unlock command depending on the locations of the device and an associated user. An electronic device may have one or more associated users. An electronic device may be locked if it is not is the same location as one of its associated users.

In one embodiment, the identification tags are radio frequency identification transponders and the location sensors are radio frequency identification readers.

A controller may receive location information transmitted by the location sensors and may store the information in the database. At least some of the location sensors may be provided at entry and exit points of a room and may include direction sensors.

The remote locking means may be provided on a server which issues commands to a service on a remote electronic device. The remote locking means may operate via a network.

According to a second aspect of the present invention there is provided a method for locking electronic devices, comprising: detecting identification tags of a user and identification tags in a plurality of electronic devices associated with a user; determining the location of an electronic device and an associated user; invoking a lock or unlock action on the electronic device dependent on whether the electronic device and an associated user are in the same location.

Detecting the location may include detecting the direction of movement at an entry or exit point. Detected location information transmitted by the location sensors may be received and stored.

Invoking a lock or unlock command may include a server issuing a command to a service on a remote electronic device. The lock or unlock command may be invoked depending on the locations of a user and an associated device.

According to a third aspect of the present invention there is provided a computer program product stored on a computer readable storage medium, comprising computer readable program code means for performing the steps of: detecting identification tags of a user and identification tags in a plurality of electronic devices associated with a user; determining the location of an electronic device and an associated user; invoking a lock or unlock action on the electronic device dependent on whether the electronic device and an associated user are in the same location.

According to a fourth aspect of the present invention there is provided a method of providing a service to a customer over a network, the service comprising: detecting identification tags of a user and identification tags in a plurality of electronic devices associated with a user; determining the location of an electronic device and an associated user; invoking a lock or unlock action on the electronic device dependent on whether the electronic device and an associated user are in the same location.

The core idea of this invention involves attaching identification tags to computers and their operators. Each office space has tag sensors at the entrances that have the ability to track movement of tags through them. In this way, it is possible to determine the location of an employee and the employee's associated electronic devices. On detecting an employee leaving the office, the system will ascertain the location of the employee's electronic devices. If an electronic device associated with the employee is in a different location to the employee, a lock command is sent to the electronic device.

This solution adds to the security of a user's computer and other electronic devices, and readily complements the current solution of locking a computer after a period of inactivity.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a schematic representation of a system of tag identification in accordance with the present invention;

FIG. 2 is a plan view of an office environment implementing a system in accordance with the present invention;

FIG. 3 is a block diagram of a computer system in accordance with the present invention;

FIGS. 4A and 4B are flow diagrams of methods of operation in accordance with the present invention starting when a user and device are in the same location; and

FIGS. 5A and 5B are flow diagrams of methods of operation in accordance with the present invention starting when a user and device are in different locations.

### DETAILED DESCRIPTION OF EXEMPLARY EMBODIMENTS

A security system is provided in which one or more users and a plurality of devices are tagged with electronic tags and the system activates locking commands on the devices when they are not in the same location as their designated user.

An embodiment of such electronic tags is provided by Radio Frequency Identification (RFID) technology, although other forms of tags and readers may be used.

Radio frequency identification (RFID) technology exists in which tags are provided in the form of transponders that are embedded in items to act as identifiers of the items. Readers or scanners act as an interface between the transponders and a data environment. Transponders and the means used to read them are available is a number of forms. Any suitable form can be used for the purposes of the present invention.

The antenna emits radio signals to activate the tag and to read and/or write data to it. Antennas can be built into a door frame to receive tag data from persons or things passing through the door. The electromagnetic field produced by an antenna can be constantly present when multiple tags are expected continually, or, if constant interrogation is not required, the field can be activated by a sensor device.

The antenna has a transceiver and decoder to provide a reader. When a tag passes through the antenna zone, it detects the reader's activation signal. The reader decodes the data encoded in the tag's integrated circuit and the data is passed to a host computer for processing.

The tags are either active or passive. Active RFID tags are powered by an internal battery and are typically read/write. Passive RFID tags are read only and operate without a power source by obtaining operating power generated from the reader. The advantage of RFID tags is they do not require contact or line-of-sight to be read.

One or more tags can be inserted into any form of object at the time of manufacture and may remain in the object until the object is destroyed. It may also be possible to destroy or deactivate the tag before the object hosting it is destroyed. Similarly a tag may be added to an object at any time during the lifetime of the object.

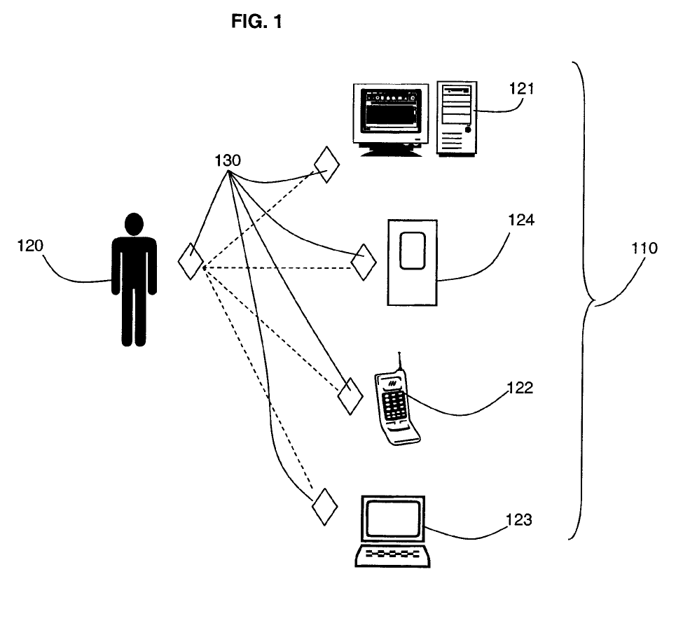

Referring to FIG. 1, a user 120 has multiple devices 110 which belong or are designated to the user. For example, the devices 110 may be in the form of a personal computer 121, a telephone 122, a laptop computer 123, and a PDA 124. The devices 110 may be easily portable, such as a laptop computer, a mobile telephone, or a PDA. Other devices 110 may be fixed or more difficult to move such as personal computers. There may be more than one user 120 who is authorized to have access to the device 110.

The user 100 and each of the devices 110 have a tag 130. The user's tag 130 may be provided as an identity card, or may be embedded in a badge or other item to be carried by the user 120. The devices 110 each have tags 130 embedded in them in a non-removable manner.

The tags 130 in the devices 110 include identification information of the device 110 in which it is embedded and, optionally, identification information of one or more users 120 associated with the device 110. The tag 130 of the user 120 includes identification information of the user 120 and, optionally, identification information of all the devices 110 associated with the user 120.

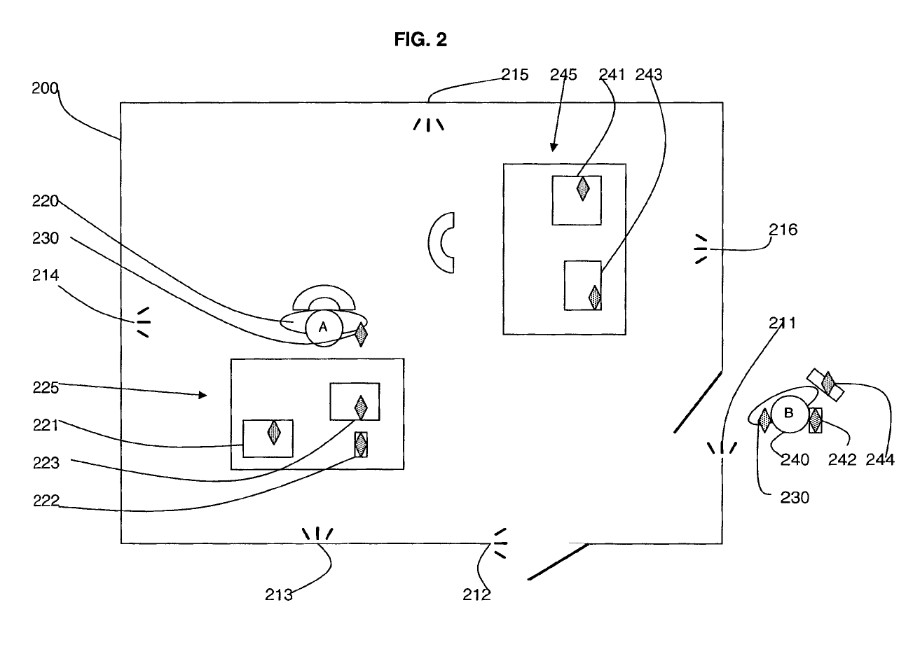

Referring to FIG. 2, a plan of an office space 200 is shown. Sensors are provided at the doors 211, 212 and on the internal walls or partitions 213-216 of the office space.

A first user A 220 has a work area 225 in the office space 200 and the first user A 220 has devices in the form of a personal computer 221, a mobile telephone 222, and a laptop computer 223. These devices 221-223 are designated as belonging to or associated with a first user A 220. First user A 220 has a tag 230 and each of the first user's devices 221-223 have embedded tags 230. The tags 230 are shown in FIG. 2 as shaded diamonds for the purposes of illustration.

A second user B 240 has a work area 245 in the office space 200. The second user B 240 has devices in the form of a personal computer 241, a mobile telephone 242, a laptop computer 243, and a PDA 244. These devices 241-244 are designated as belonging to the second user B 240. Second user B 240 has a tag 230 and each of the second user's devices 241-244 have embedded tags 230.

FIG. 2 shows the first user A 220 sitting at his desk in his work area 225. The work area 225 is scanned by sensors 213 and 214 mounted on the walls near the work area 225 detecting the tags 230 of the first user A 220 and all his devices 221-223 which are with him in the work area 225.

FIG. 2 shows the second user B 240 walking out of the office space 200. He has left his work area 245 and passed the door sensor 211 leaving the office space 200. Second user B 240 is carrying his mobile telephone 242 and has his PDA 244 with him but has left his personal computer 241 and his laptop computer 243 on his desk in his work area 245. Wall sensors 215, 216 mounted on walls near his work area 245 scan the tags 230 in the personal computer 241 and the laptop computer 243. The door sensor 211 scans the tags 230 of the second user B 240 and his mobile telephone 242 and his PDA 244.

RFID sensors 211-216 detect the presence of compatible RFID tags 230 nearby. By placing RFID sensors at the entrance and exit points of designated rooms it is possible to detect when a user or device carrying an RFID tag is nearby. By combining this information with data obtained from direction sensors at the same entry or exit point it is possible to determine that a certain user or a device has entered or exited a room. If the last detected event for a user or device is to have entered a room, the system will implicitly assume that this user or device is currently present in this room.

An office space 200 can be divided into areas, which may be of uniform size or which may vary in size. One or more sensors may scan an area. Sensors may also be provided at points of entry or exit from areas.

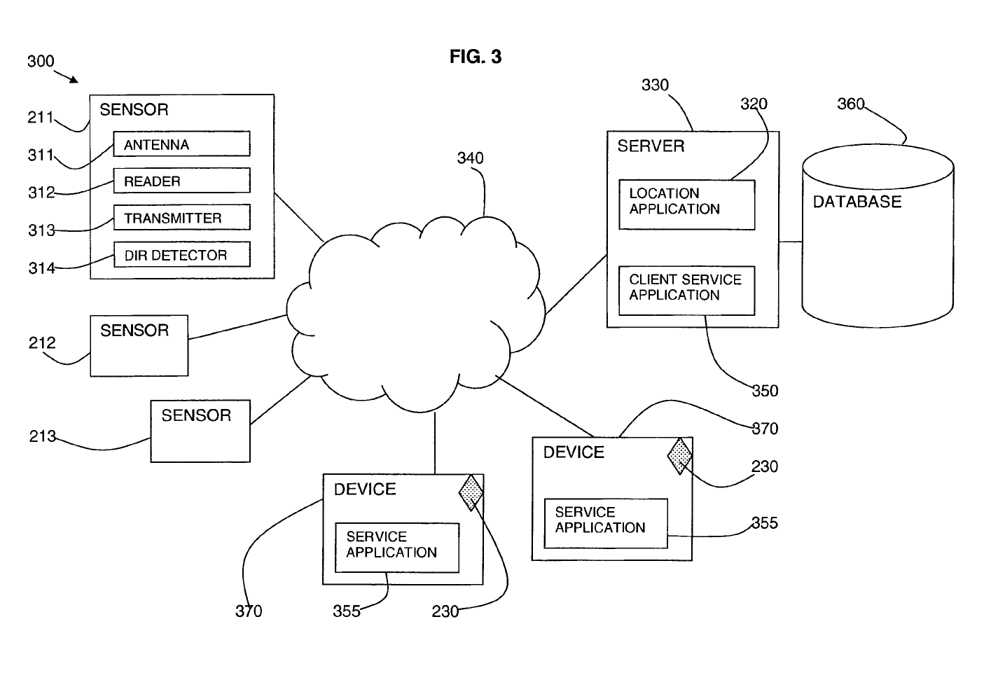

Referring to FIG. 3, a system 300 is shown. A plurality of sensors 211-213 are provided each with an antenna 311, a reader 312 and a transmitter 313. Sensors 211, 212 which are located on entry or exit points of an area also have direction detectors 314 to determine if a tag has passed into or out of an area.

The sensors 211-213 transmit data read from tags to a location application 320 which is provided on a server 330. The data may be transmitted via a network 340, for example, a LAN, or the Internet.

The server 330 also runs a client service application 350. Client devices 370 with tags 230 (for example, a tagged personal computer 221 or a tagged mobile telephone 222) run the client side 355 service applications 350 via the network 340. The service application 350 enables commands to be sent by the server 330 to a client device 370 to lock the device 370.

The server 330 is also coupled to a database 360 which persistently stores the location information of the users and devices. By having this location information available, it is possible to determine whether a device and its owner are situated in the same or different places. Furthermore, the system will store an association between a device and its owner, with the possibility of having more than one device linked to a particular user.

Each tagged device 370 has a service application 355 running that is able to receive commands from the centralized server 330. Whenever the system detects that a user or device leaves an area (for example, a room), the location of the user in question is derived, followed by the location of the devices assigned to the user. If it is the case that any of these associated pairs of entities are in different locations, a message is sent to the service 355 running on the device 370, which secures the device 370 (for example, by issuing the lock command to a computer).

As a further refinement, the system will only lock if the two entities are in different locations to each other for predetermined amount of time (e.g. approximately 5 seconds) after the location change is detected. This is to ensure that a lock command is sent in error due to a delay in the system's location sensing mechanism.

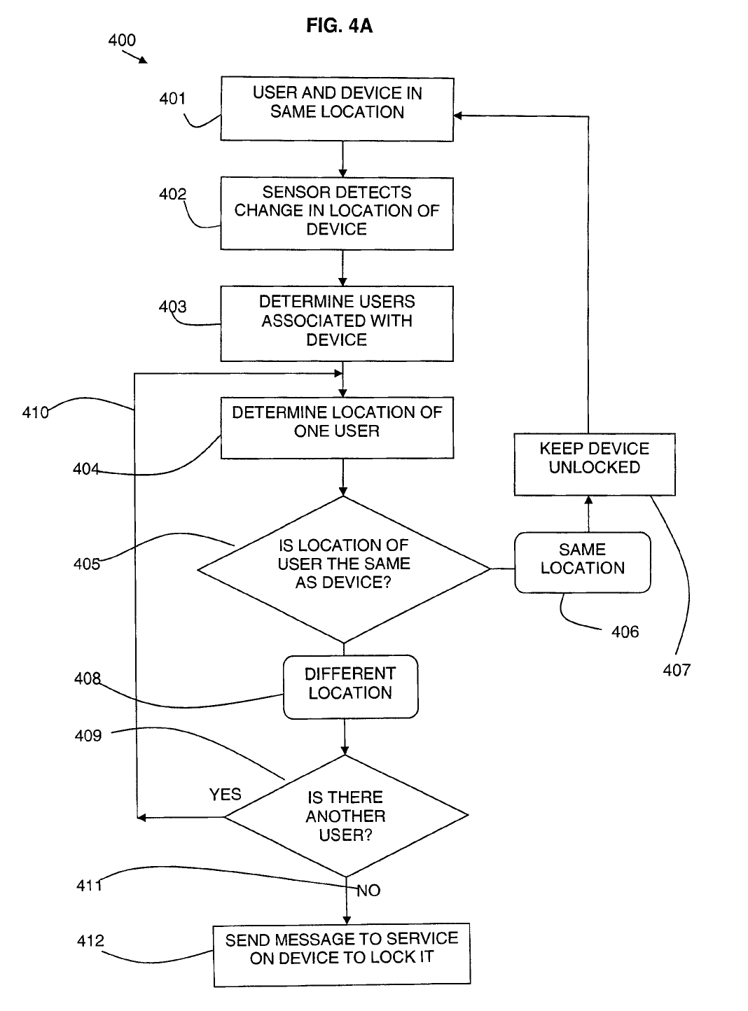

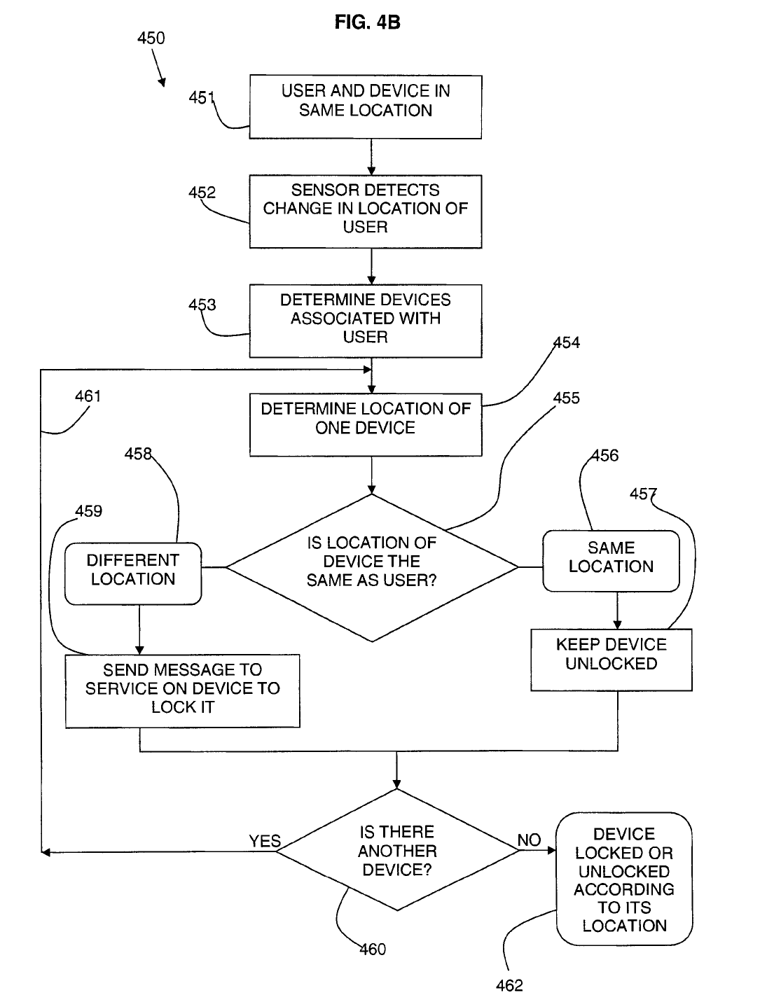

FIGS. 4A and 4B are flow diagrams 400, 450 of methods of operation as implemented by the server 330 starting when a user and device are in the same location.

The flow diagram 400 of FIG. 4A starts with a user and a device in the same location 401 and therefore the device is unlocked. A sensor detects 402 the change in location of the device, for example, a door sensor may detect movement of the device out of a room or work area.

There may be a number of scenarios in which the device leaves a location, including the following:

the user who started off in the same location as the device has changed location with the device, for example, by carrying the device out of a room;

another associated user has taken the device from the location whilst the first user remains in the location; or

an unauthorized person has taken the device from the location.

A device may have more than one associated user and these users are determined 403 in the next step of the method. The method then determines 404 the location of one of the associated users and whether or not the location is the same as the location of the device 405. If the location is the same as the device 406, the device is kept unlocked 407. As the device is with one of the associated users, the location of any other associated users is not relevant and therefore the method returns to the start 401 with a user and the device in the same location.

However, if the location 408 is not the same as the location of the device, it is then determined 409 if there is another associated user. If so, the method loops 410 to determine 404 the location of the next associated user. If the location 408 is not the same as the device and there are no further associated users 411, a message is sent to the service on the device to lock it 412. The device is locked as it is not in the same location as any one of the associated users.

The flow diagram 450 of FIG. 4B also starts with a user and a device in the same location 451 and therefore the device is unlocked. A sensor detects 452 the change in location of the user, for example, a door sensor may detect movement of the user out of a room or work area. In this case it is necessary to lock all devices which the user has left behind, whilst keeping unlocked any devices the user has taken with him.

The method determines 453 the devices associated with the user and determines 454 the location of each device in turn. It is determined 455 if the location of the device is the same as the location of the user. If the location is the same 456, the device is kept unlocked 457. If the location is not the same 458, a message is sent to the service on the device to lock it 459. In both case, the method proceeds to determine 460 if there is another device. If there is another device, the method loops 461 to determine the location of the next device 454. If there are no more devices, the method ends with each device being locked or unlocked according to its location 462.

There may be an extra iteration of the method once it is determined that a device is in a different location to the user 458, in that it may be in the same location as another associated user.

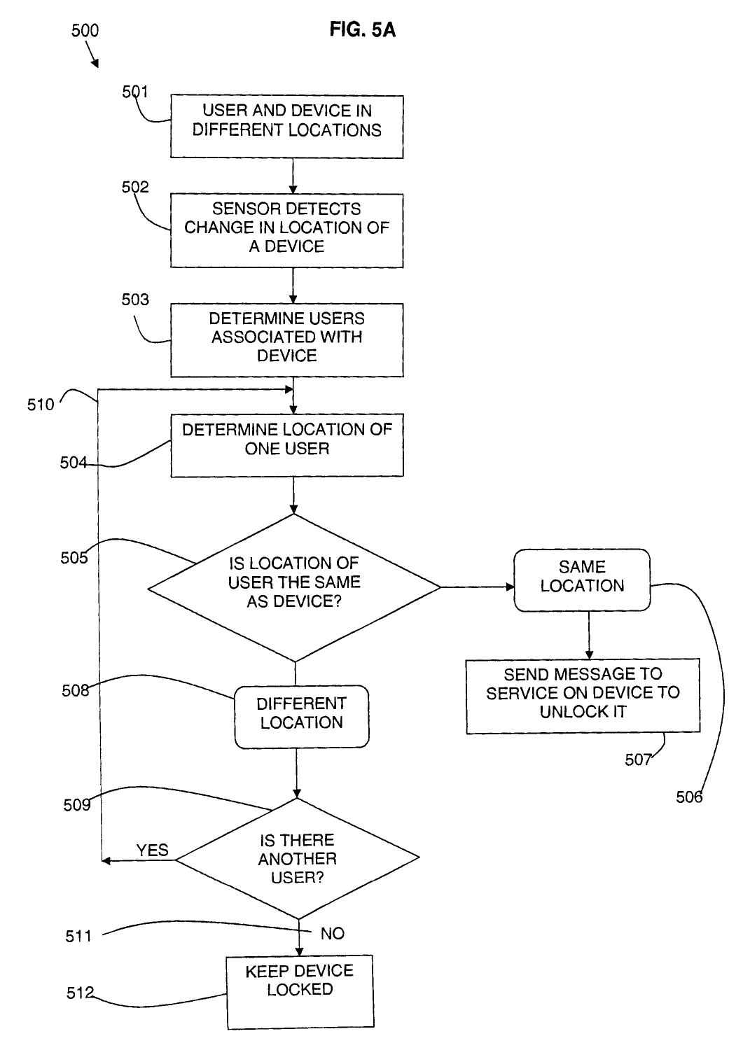

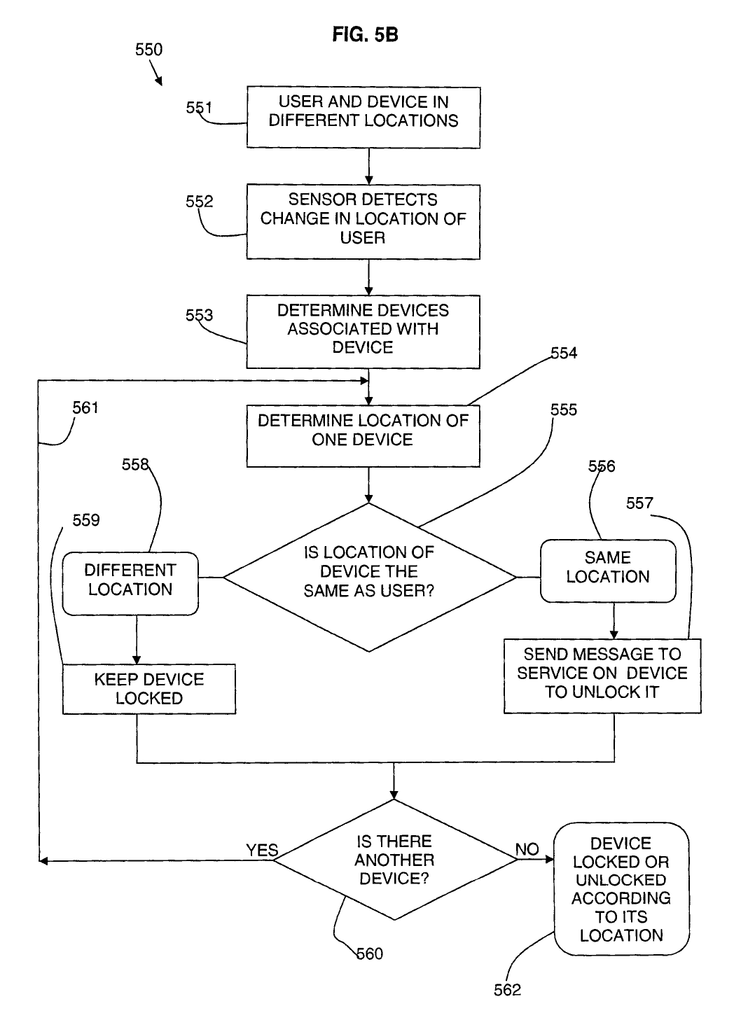

FIGS. 5A and 5B are flow diagrams 500, 550 of methods of operation as implemented by the server 330 starting when a user and device are in different locations.

The flow diagram 500 of FIG. 5A starts with the user and device in different locations 501. A sensor detects 502 a change in location of a device. The users associated with the device which has moved are determined 503.

The method then determines 504 the location of one of the associated users and whether or not the location is the same as the location of the device 505. If the location is the same as the device 506, a message is sent to the service on the device to unlocked it 507 as it is now in the same location as an associated user. As the device is with one of the associated users, the location of any other associated users is not relevant and therefore the method ends with a user and the device in the same location.

However, if the location 508 is not the same as the location of the device, it is then determined 509 if there is another associated user. If so, the method loops 510 to determine 504 the location of the next associated user. If the location 508 is not the same as the device and there are no further associated users 511 the device remains locked 512.

The flow diagram 550 of FIG. 5B starts with the user and device in different locations 551.

A sensor detects 552 the change in location of the user, for example, a door sensor may detect movement of the user into a room or work area. In this case it is necessary to unlock all devices in the location the user has arrived at.

The method determines 553 the devices associated with the user and determines 554 the location of each device in turn. It is determined 555 if the location of the device is the same as the location of the user. If the location is the same 556 a message is sent to the device to unlock it 557. If the location is not the same 558, the device remains locked 559. In both case, the method proceeds to determine 560 if there is another device. If there is another device, the method loops 561 to determine the location of the next device 554. If there are no more devices, the method ends with each device being locked or unlocked according to its location 562.

Using these methods the following examples may occur.

Whenever a user leaves a room, his devices will be automatically secured thus ensuring the security of data. For example, his computer will lock, and he will be logged out of his phone.

If a laptop is taken from a room in which the owner is present (i.e. someone else is removing the laptop) the computer will automatically lock.

Whenever an employee enters the room in which his computer is located, an unlock command is automatically sent to the computer.

The operation of the location application and client service application may be provided as a service to a customer over a network.

The figures include block diagram and flowchart illustrations of methods, apparatus(s) and computer program products according to an embodiment of the invention. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed.

We claim:

1. A system for locking electronic devices, comprising:
a plurality of identification tags each identifying a user;
a plurality of electronic devices each having an identification tag;
location sensors for detecting the location of a tag;
a database storing location information of tags and associations of a user with a plurality of devices; and
a remote locking means to invoke a lock command or an unlock command on an electronic device.

2. A system as claimed claim 1, wherein the remote locking means invokes a lock command or an unlock command depending on the locations of a user and an associated device.

3. A system as claimed in claim 1, wherein the identification tags are radio frequency identification transponders and the location sensors are radio frequency identification readers.

4. A system as claimed in claim 1, wherein a controller receives location information transmitted by the location sensors and stores the information in the database.

5. A system as claimed in claim 1, wherein at least some of the location sensors are provided at entry and exit points of a room and include direction sensors.

6. A system as claimed in claim 1, wherein the remote locking means is provided on a server which issues commands to a service on a remote electronic device.

7. A system as claimed in claim 1, wherein an electronic device can have one or more associated users.

8. A system as claimed in claim 1, wherein an electronic device is locked if it is not is the same location as one of its associated users.

9. A system as claimed in claim 1, wherein the remote locking means operates via a network.

10. A method for locking electronic devices, comprising:
detecting identification tags of a user and identification tags in a plurality of electronic devices associated with a user;
determining the location of an electronic device and an associated user;
invoking a lock or unlock action on the electronic device dependent on whether the electronic device and an associated user are in the same location.

11. A method as claimed in claim 10, wherein the identification tags are radio frequency identification transponders and the location is determined by radio frequency identification readers.

12. A method as claimed in claim 10, wherein location information transmitted by location sensors is received and stored.

13. A method as claimed in claim 10, wherein detecting the location includes detecting the direction of movement at an entry or exit point.

14. A method as claimed in claim 10, wherein invoking a lock or unlock command includes a server issuing a command to a service on a remote electronic device.

15. A method as claimed in claim 10, wherein the lock or unlock command is invoked depending on the locations of a user and an associated device.

16. A method as claimed in claim 10, wherein an electronic device can have one or more associated users.

17. A method as claimed in claim 10, wherein an electronic device is locked if it is not is the same location as one of its associated users.

18. A method as claimed in claim 10, wherein lock and unlock commands are invoked via a network.

19. A computer program product stored on a computer readable storage medium, comprising computer readable program code means for performing the steps of:
detecting identification tags of a user and identification tags in a plurality of electronic devices associated with a user;
determining the location of an electronic device and an associated user;
invoking a lock or unlock action on the electronic device dependent on whether the electronic device and an associated user are in the same location.

20. A method of providing a service to a customer over a network, the service comprising:
detecting identification tags of a user and identification tags in a plurality of electronic devices associated with a user;
determining the location of an electronic device and an associated user;
invoking a lock or unlock action on the electronic device dependent on whether the electronic device and an associated user are in the same location.
